(19) United States
(12) Patent Application Publication
(10) Pub. No.: US 2012/0076970 A1
(43) Pub. Date: Mar. 29, 2012

(54) Traffic cone and ribbon attachment device

(76) Inventor: Rickie L. Suter, Sunnyvale, CA (US)

(21) Appl. No.: 12/924,381

(22) Filed: Sep. 27, 2010

(51) Int. Cl. B32B 3/02

(52) U.S. Cl. 428/80

(57) ABSTRACT

This invention is a unique and novel method and device that facilitates attaching objects to and between holes. The invention is an insertable, removable and a reusable device that provides a method for attaching ribbons, ropes, chains or any other object of acceptable size, to a hole of acceptable dimensions. When the device is properly installed into a hole, an arch is formed by the device on one side of the hole so that an object could pass thru this arch and be held securely to the hole, allowing other holes to be interconnected.

### SUMMARY OF INVENTION

This invention provides a unique and novel way of solving an age old problem, that is how to attach a ribbon, rope, chain or any other object of acceptable size, to a hole at the top of a traffic (or safety) cone or any hole that is of similar dimension to a traffic (or safety) cone. The problem is that if in most cases when a person is trying to protest an area with traffic cones, (I will use traffic cones for example, this is not the limit of the use of the device to this use), the space between the cones is vulnerable to people walking right through that space and into some sort of hazard. A rope or a ribbon with words of warning between the cones is a good barrier for this space in most cases. There are many methods that have been tried and all create their own pesky problems. Such as placing a stick through the cones top hole or wrapping the caution ribbon around the top of the cone or by using Duct Tape. With these methods there are many problems, to +mention a few;

With duct tape;

The tape gets dirty and peals loose,

Loose and dirty tape makes for a run down or low budget appearing operation, not professional looking,

When using duck tape the tape will normally partly cover the upper quarter of the traffic cone and if the traffic cone has the reflective rings, the tape usually will partly covering the upper reflective ring diminishing the effectiveness of the reflective ring.

With loose and dirty tape the cones when stacked together, for transportation, they are sometimes imposable to separate.

With the stick method;

A storage location for the sticks is necessary,

Collection and redeployment of the sticks, for every use, is time consuming,

Wrapping and removing the ribbon with every use,

Unless great care is taken in retrieving the ribbon after each location it is used it will become a massive ball of knots and will normally just be thrown away.

Throwing away ribbon after one or two uses is costly.

Throwing away the ribbon after one or two uses is a burden on our landfills.

With the wrapping method;

Wind is the major defeat for this method; a gentle breeze can float the ribbon up and off the cone,

Wrapping and removing the ribbon with every use, is time consuming,

Unless great care is taken in retrieving the ribbon after each location it is used it will become a massive ball of knots and will normally just be thrown away.

Throwing away ribbon after one or two uses is costly.

Throwing away the ribbon after one or two uses is a burden on our landfills.

My invention addresses all of the problems;

My invention has a Neat and professional look, the ribbon and my invention are neatly at the top of the cones,

My invention is a time saving device, once inserted in the cone with the ribbon, the ribbon and the my invention are left in place while the cones are retrieved and stacked, the cones, with ribbon still attached can be quickly deployed with ribbon still attached by my invention,

My invention is a resource saver, being able to stack the cones with the ribbon still attached, the ribbon is reused for many many more location of use,

My invention is environmentally friendly, being able to reuse the ribbon, less ribbon is thrown away into the landfills and the environment,

My invention holds the ribbon securely to the cone in high winds,

My invention is a space saver, there are no extra items to store and the ribbon is neatly stored with the cones,

My invention is a time, money and environment saver.

### EMBODIMENT OF MY INVENTION

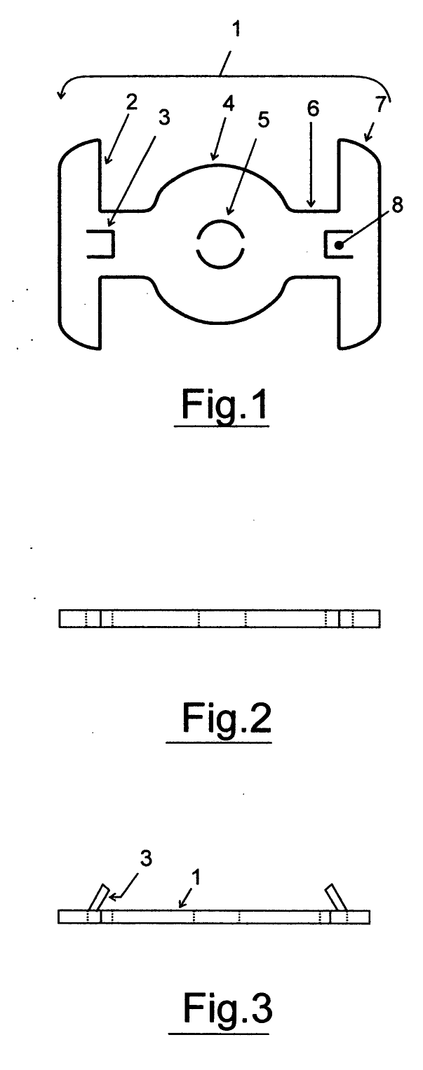

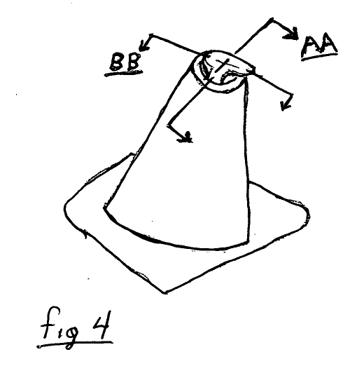

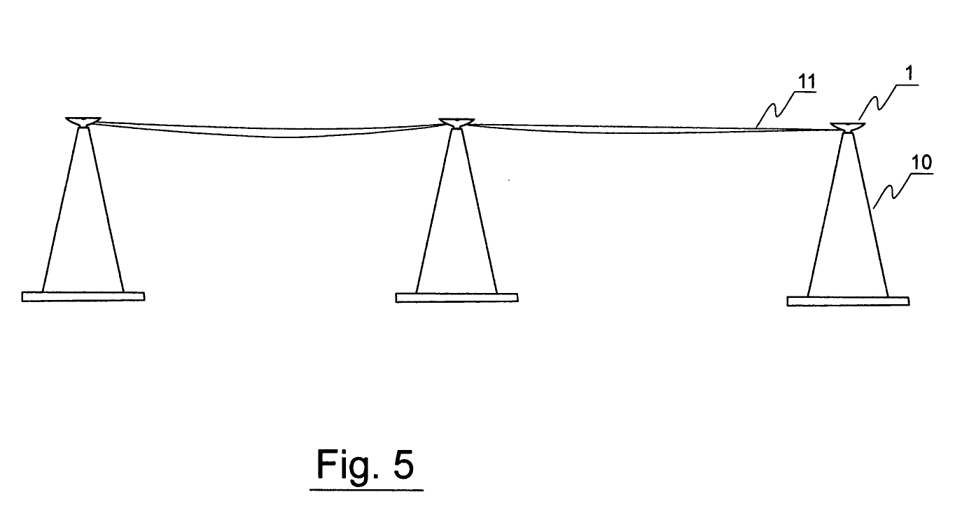

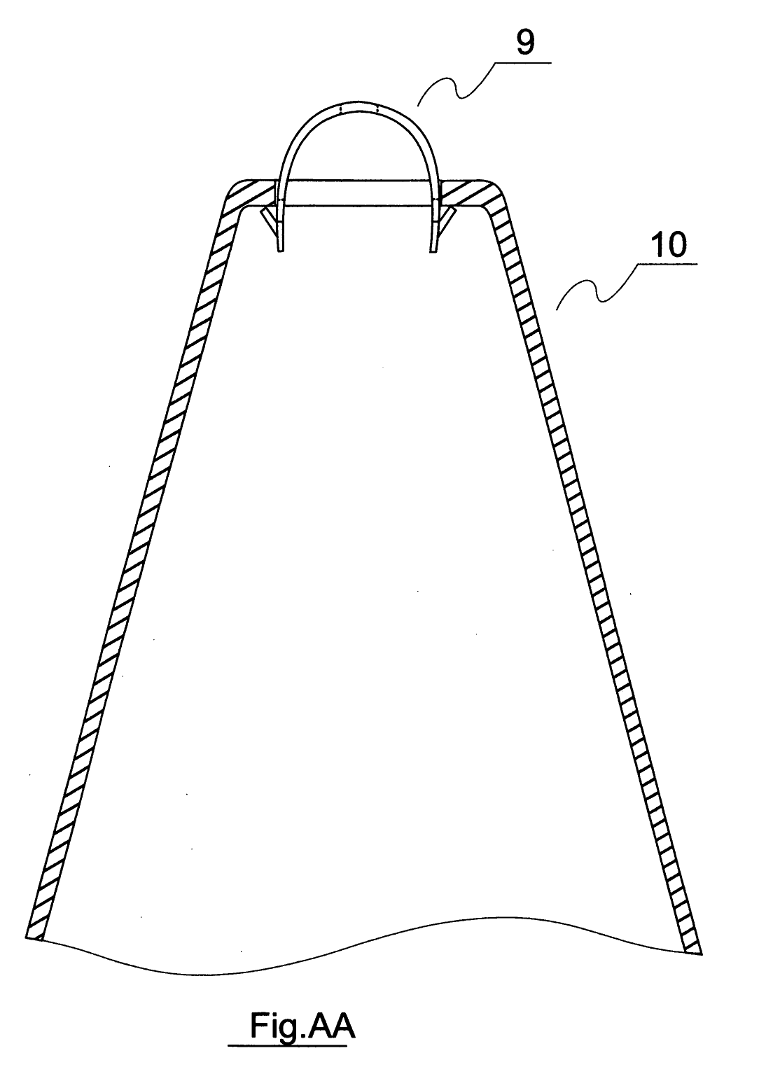

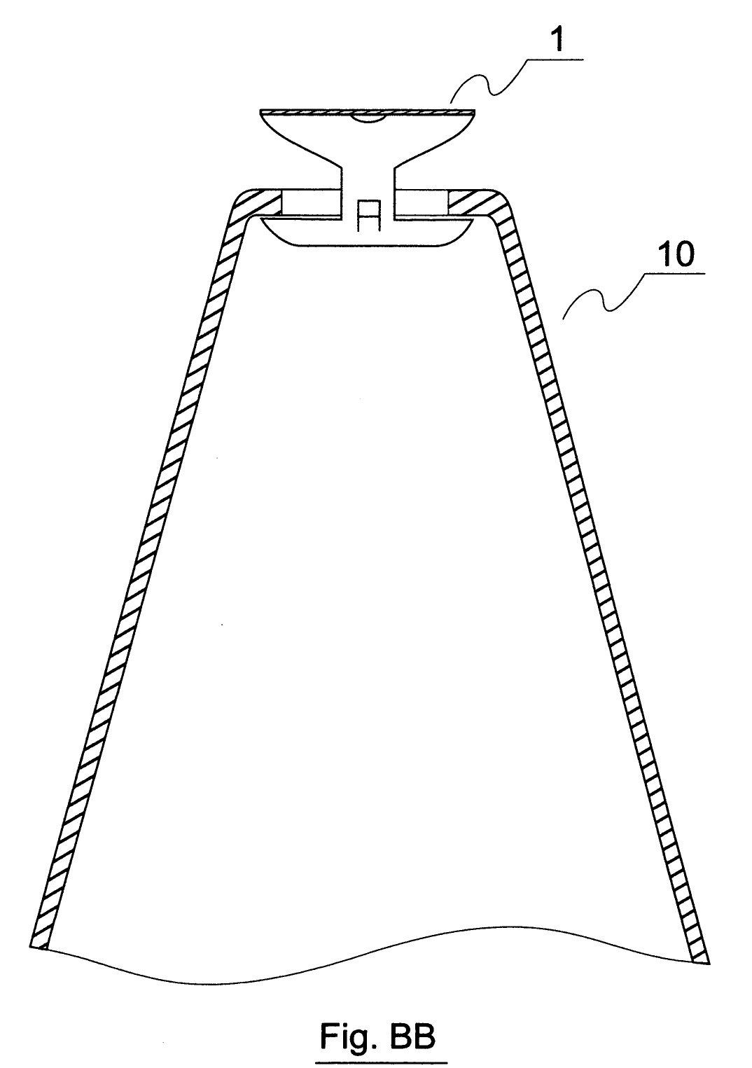

The embodiment of the invention before insertion, as viewed from above is, a flat flexible material that has an oval at its center-point (FIG. 1-4), of such a size to keep the devise from passing thru the hole at the top of a traffic cone (FIG. BB-10) and of such a size to form a large enough arch (FIG. AA-9) (when inserted) to pass thru the objects and of such a size that the oval will not interfere (or jam) on the inside of a stacked cone. At opposing ends from the center point along the center line and emanating from the outer edge of the oval, are at least two appendages (FIG. 1-6), (to be referred here in as the legs), that are of such a width that they will minimize the distortion of the opening of the cone and of such a length to allow the devise to move up and down when inserted into the hole. At the outer end point of each leg are two rectangular appendages (FIG. 1-2) that are perpendicular to the center line, on opposing sides from the center line and of equal dimension, the length of this appendage from the center line is about equal to the greatest radius of the center oval and a length along the center line is great enough to prevent easy removal from the hole, the corner furthest from the center point is rounded (FIG. 1-7) and is of such an arch to ease the insertion of the device into the hole. This appendage is used to stabilize the device. On the center line of each leg is a three sided squared cutout (FIG. 1-3) that the length of each side is about one quarter to one third the width of the leg, where the flap side is opening towards the center point. The flaps center point (FIG. 1-8) is located at the intersection of the center line and the legs outer end. This flap assist in the retention the device.

### History of my Invention

My name is Rick Suter the inventor of, what I believe is one of the greatest innovations in safety sense the seat belt, the ConeTopper©.

ConeTopper © saves time, material, reduce your liability exposure and increase that professional look that we all strive for. That all adds up to Saving Money and Making Money. You ask how?

First let me tell you about ConeTopper ©. ConeTopper © is a relatively small uniquely shaped, highly recyclable device made of HDPE plastic. It has a UV protective coating, ensuring years of outside use. And because of the type of plastic used it can take years of abuse. I am also proud to say,

### Made in the United States of America

Having worked in the construction business on and off for many years, there was always this nagging problem of how to protect my work area using those orange safety cones. I use cones because those tall poles with that heavy weight (delineators), are too awkward. I could only handle two at a time and they take up so much space when storing them also after every job I would have to throw the ribbon away because the ribbon was such a mess. I tried everything from, looping the caution tape around the cones, to the mistake of duct taping the ribbon on the cones (I never could get them apart after that). I finally, out of frustration, tied a rock to the ribbon inside the cones. Eureka that kept the ribbon in place. Well that worked, but that turned out to be even more of a hassle. When stacking them, the rock would jam or fall all the way through and tangle the ribbon. I would have to remove the rocks and throw the ribbon away, wasting time and resources, and that's wasting money. Turning to wire, I played with some interesting designs, none that really worked out. Then one day working around the house an idea came to me. I went to the garage and grabbed a pair of scissors and an old cat litter bottle. I started cutting and thinking. Going through many designs, I got it, and ConeTopper © was born. All of those problems were solved. I simply inserted ConeTopper © into the hole on the top of the cones and attached the ribbon to the cones securely (stringing the ribbon between cones). When I was finished with that area, I simply stacked the cones (with ConeTopper © and the ribbon still attached) throw them in the back of my truck and deployed them in the new location. This not only saved me the time of restringing the ribbon but I then didn't have to through the ribbon away. That was a double hitter. I not only saved the expense of buying the ribbon again, I am also keeping all that ribbon out of the landfills a little longer.

ConeTopper © saves time, expenses and reduces your liability exposure.

ConeTopper © Saves time by conveniently having the ribbon already attached to the cones for easy and fast deployment.

ConeTopper © also saves the expense of always having to buy ribbon.

ConeTopper helps reduce your liability exposure by having a clear and well defined line. This helps protect your work area and shows the public clearly where not to be. If they should cross the line then, well they then have crossed the line, a more defendable position. And in this economic time it seems that more people are looking for that easy buck (the law suit). ConeTopper © can't guarantee someone won't cross the line and win, but without the ribbon your' not doing your best to protest yourself, that's an open invitation.

I claim:

1. My invention is made of a flat flexible material with oval shapes and appendages and tabs and a hole cut out at its center,

2. My invention as claimed in claim 1 an oval shape about the size of the opening in the top of a safety cone

3. My invention as claimed in claim 1 has at least two appendages,

4. My invention as claimed in claim 1 has at least two tabs.

5. My invention as claimed in claim 1 has at least one cut out,
